(19) United States
(12) Patent Application Publication
(10) Pub. No.: US 2009/0284635 A1
(43) Pub. Date: Nov. 19, 2009

(54) DISPLAY DEVICE HAVING OPTICAL ZOOM CAMERA MODULE

(76) Inventors: FU-HSIANG SUNG, Hsin Chu Hsien (TW); Tze-Yun Sung, Hsin Chu Hsien (TW); Huang-Chih Hsu, Hsin Chu Hsien (TW)

Correspondence Address: LEONG C LEI, PMB # 1008, 1867 YGNACIO VALLEY ROAD, WALNUT CREEK, CA, 94598, US

(21) Appl. No.: 12/273,565

(22) Filed: Nov. 19, 2008

(30) Foreign Application Priority Data
May 13, 2008 (TW) 097208230

(51) Int. Cl. H04N 5/222; H04N 5/232

(52) U.S. Cl. 348/333.01; 348/347; 348/E05.022; 348/E05.042

(57) ABSTRACT

The display device contains a flat panel mounted in a frame and a camera module positioned inside a through opening in the top rim of the frame. A camera of the camera module is located at a lateral side of the camera module. With the increased space achieved, the camera is able to provide optical zoom capability. The top and bottom sides of the camera module are pin-joined to a top wall and a bottom wall of the through opening, respectively, so that the camera module could be revolved laterally inside the through opening of the flat panel's frame.

### TECHNICAL FIELD OF THE INVENTION

The present invention generally relates to flat-panel display devices, and more particularly to a flat-panel display device having a built-in, laterally revolving camera module with optical zoom capability.

### DESCRIPTION OF THE PRIOR ART

As notebook computers have become the mainstream product of personal computing, there are notebook computers having a camera module (usually working as a web camera) built into the upper rim of a notebook computer's flat liquid crystal display (LCD) panel. However, as the notebook computers are continuously demanded to be thinner, the dimension limitation to the camera module has limited its function significantly. For example, optical zoom involving the physical change to the location of the camera lens is very difficult to implement under the current design of notebook computer's camera module.

In addition, there are notebook computers having their camera module's left and right sides pin-joined to a socket in the upper rim of the LCD panel, so that the camera module is vertically rotatable. In other words, the vertically rotatable camera module could be turned to cover pretty much anywhere in front of the LCD panel. However, to capture images of what is to the left or right side of the notebook computer, a user still has to turn the entire notebook computer to face its left or right side.

### SUMMARY OF THE INVENTION

Accordingly, a novel flat-panel display device is provided herein which has a built-in laterally revolving camera module with optical zoom capability.

The display device contains a flat panel mounted in a frame and a camera module positioned inside a through opening in the top rim of the frame. A camera of the camera module is located at a lateral side of the camera module. With the increased space achieved, the camera module is able to provide optical zoom capability. The top and bottom sides of the camera module are pin-joined to a top wall and a bottom wall of the through opening, respectively, so that the camera module could be turned laterally inside the through opening of the flat panel's frame.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram of a display device in accordance with an embodiment of the present invention.

FIG. 2 is a perspective diagram of a display device in accordance with another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

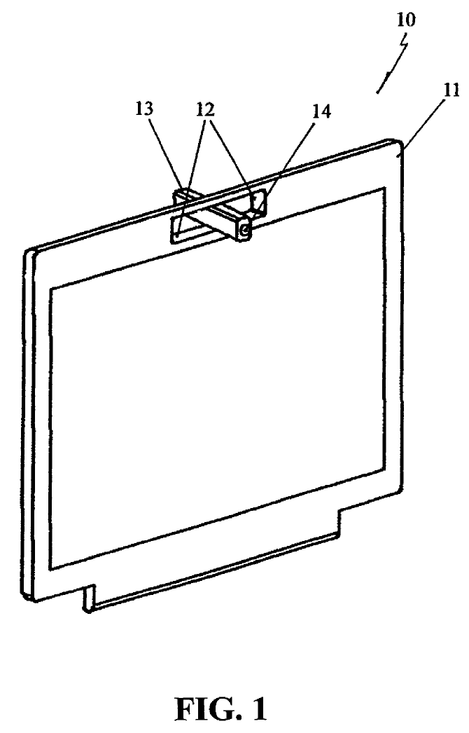

As shown in FIG. 1, a display device 10 according to an embodiment of the present invention contains a flat panel 11 mounted in a frame and a rectangular camera module 13 having a camera 14 at a lateral side (i.e., left or right side) of the camera module 13.

As illustrated, at the center of a top rim of the flat panel 11's frame, there is a through opening 12 matching the shape of the camera module 13 but slightly larger so that the entire camera module 13 could be accommodated.

A top side and a bottom side of the camera module 13 are pin-joined to a top wall and a bottom wall of the through opening 12. Please note that the pins (not shown) are vertically aligned through the center of the camera module 13. As such, the camera module 13 could be turned 360-degree within the through opening 12, just like a revolving door. Therefore, the camera 14, revolved along with the camera module 13, is capable of capturing images of anywhere around the display device 10.

Please note that, in contrast to conventional camera modules where their cameras are located at the center of a major side of the thin camera module, the camera module 13 of the present invention has more depth for the implementation of optical zoom in the camera with involves the physical change of the camera's lens location.

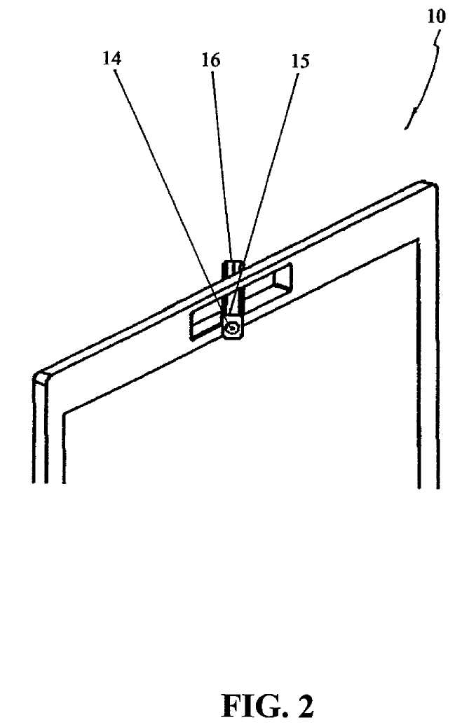

Additionally, as shown in FIG. 2, in addition to having the camera 14 located at a lateral side 15 (e.g., left side) of the camera module 13, an additional camera could be added and located at the other lateral side 16 (e.g., right side) of the camera module 13. In other words, the camera module 13 could have two cameras at its lateral sides, respectively. The cameras therefore could cover the two separate areas in front of them simultaneously.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A display device, comprising:
a flat panel mounted in a frame whose top rim has a through opening; and
a camera module having at least a camera with optical zoom capability at a lateral side, said camera module slightly smaller than and positioned inside said through opening, a top side and a bottom side of said camera module joined to a top wall and a bottom wall of said through opening by two vertically aligned pins, respectively, so that said camera module is laterally rotatable inside said through opening.
